(19) United States
(12) Patent Application Publication
(10) Pub. No.: US 2009/0198414 A1
(43) Pub. Date: Aug. 6, 2009

(54) Operator interface for controlling a vehicle

(75) Inventors: Alex R. Mohning, Leicestershire (GB); Jamie L. McClintock, Washington, IL (US); Benjamin Drake, Haute Jarrie (FR); Corwin Storer, Bastonville, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/012,285

(22) Filed: Jan. 31, 2008

(51) Int. Cl. B62D 1/12; B62D 6/00

(52) U.S. Cl. 701/41; 280/93.5

(57) ABSTRACT

An operator interface for controlling a vehicle includes a first operator control input device configured to generate a first signal indicative of a desired steering of the vehicle, and a second signal. The operator interface also includes a second operator control input device configured to generate a third signal. The second signal and the third signal are indicative of a desired vehicle speed.

### TECHNICAL FIELD

This patent disclosure relates generally to operator interface and, more particularly to an operator interface for controlling a vehicle.

### BACKGROUND

Vehicles such as, for example, construction and other work machines; automobiles, trucks, and other over the road vehicles; marine vessels; and aircraft have more recently employed multi-function joysticks and other multi-function operator control devices to control steering, speed, and secondary functions of subsystems such as work implements. There are times and applications when controlling multiple vehicle functions with one operator control device may require high levels of operator concentration. At times, this may be difficult and stressful for inexperienced operators. For example, when a joystick is used to control both steering and vehicle speed, and the vehicle is being used in an application where a large amount of maneuvering is necessary, it may be challenging for an operator to concentrate on the correct joystick position for steering while also having to control speed through the joystick position. When the vehicle is being operated at low speeds, the joystick displacement for small increases and decreases of speed may be small. This can increase the difficulty in operating the vehicle.

Some vehicles have operator interfaces which include selection of one of multiple operating modes. The operating modes modify the operator interface for use in specific applications or situations. One such mode selection is the high power/low power mode selection commonly referred to as the rabbit/turtle mode (or tortoise/hare mode) selection. This feature allows an operator to choose a low power mode which scales operator inputs to that mode. Although helpful, operators may still find steering and controlling speed or power through one joystick or control device difficult or stressful in some situations.

U.S. Pat. No. 7,233,853 issued to Hendron et al. discloses a work vehicle multi-operational mode system. In one mode a joystick controls work implements, and braking is controlled through a brake pedal. In a second mode, the joystick controls the vehicle motion, including speed and steering. Although Hendron may assist operators with a more user friendly interfaces for different applications, in one mode, the operator must still control steering and speed with a joystick at all times.

### SUMMARY

An operator interface for controlling a vehicle is disclosed. The operator interface includes a first operator control input device configured to generate a first signal indicative of a desired steering of the vehicle, and a second signal. The operator interface also includes a second operator control input device configured to generate a third signal. The second signal and the third signal are indicative of a desired vehicle speed.

Additionally, a vehicle is disclosed. The vehicle includes a propulsion system, a steering apparatus, a retarding system, and the disclosed operator interface. The vehicle also includes a controller configured to generate a control signal operable to maintain or modify operation of the propulsion system, the steering apparatus, or the retarding system. The control signal is a function of the first signal, the second signal, and the third signal.

A method for controlling a vehicle is also disclosed. The method includes the steps of determining a first input from a first operator control input device indicative of a desired steering, determining a second input from the first operator control input, and determining a third input from a second operator control input. The second input and the third input are indicative of a desired speed. The method also includes the step of generating a control signal operable to maintain or modify operation of a vehicle propulsion system, steering apparatus, or retarding system as a function of the first signal, the second signal, and the third signal.

### BRIEF DESCRIPTION OF THE DRAWINGS

The accompanying drawings, which are incorporated in and constitute a part of this specification, illustrate exemplary embodiments or features of the disclosure and, together with the description, help explain principles of the disclosure. In the drawings,

FIG. 1 is a schematic illustration of a vehicle control system including an operator interface;

FIG. 2 is a schematic illustration of the operation of a joystick;

FIG. 3 is a diagrammatic illustration of an exemplary vehicle as seen from a top view; and

FIG. 4 is a flow chart of an exemplary method for controlling a vehicle.

Although the drawings depict exemplary embodiments or features of the present disclosure, the drawings are not necessarily to scale, and certain features may be exaggerated in order to provide better illustration or explanation. The exemplifications set out herein illustrate exemplary embodiments or features, and such exemplifications are not to be construed as limiting the inventive scope in any manner.

### DETAILED DESCRIPTION

Reference will now be made in detail to specific embodiments or features, examples of which are illustrated in the accompanying drawings. Generally, the same or corresponding reference numbers will be used throughout the drawings to refer to the same or corresponding parts.

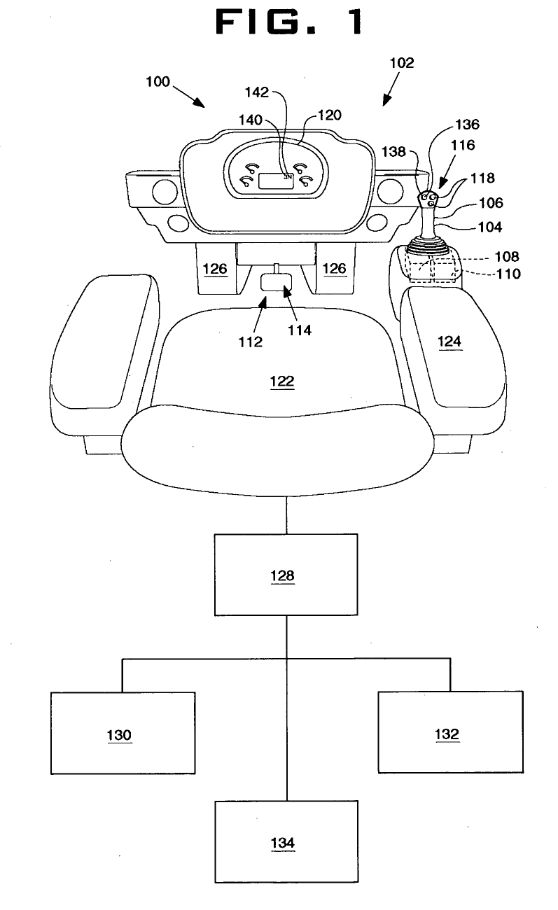

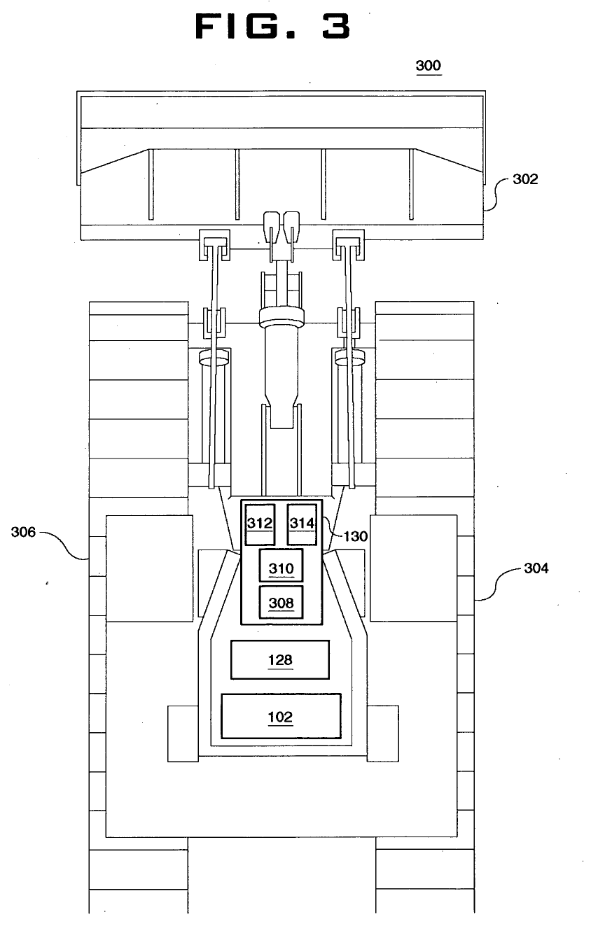

FIG. 1 illustrates an exemplary embodiment of a control system 100. The control system may be on a vehicle 300 (See FIG. 3). The control system 100 may include an operator interface 102. The operator interface 102 may include devices with which a vehicle operator communicates with, interacts with, or controls the vehicle 300. In one embodiment, the operator interface 102 may include devices with which the operator interacts physically. In another embodiment, the devices may operate with voice activation. In still other embodiments, the operator may interact with the operator interface 102 in any way a person skilled in the art would contemplate now or in the future.

The operator interface 102 may include a first operator control input device 104, a second operator control input device 112, a third operator control input device 116, a display 120, an operator seat 122, an arm rest 124, and a foot rest 126.

The first operator control input device 104 may include a joystick 106. The joystick 106 may include a hand operated lever-type control device, with a generally elongated shape, movable in at least one direction. The joystick 106 may be operable to move in several directions.

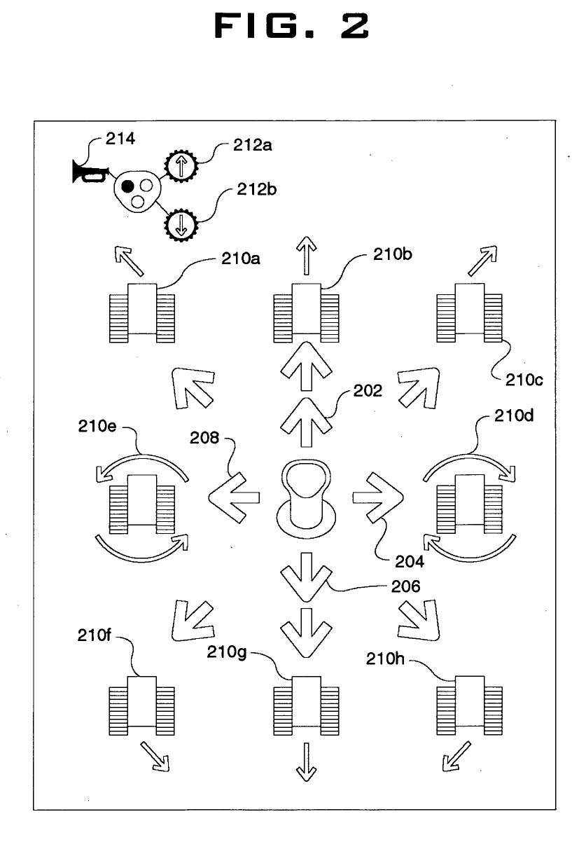

The joystick 106 may include operator control features 136 in addition to displacement. For example, the joystick may include a depressible device 138 which actuates an audible signal such as a horn 214 (see FIG. 2) Operator control features may include buttons or other depressible devices, switches, rotatable members, and slidable members. Control inputs may be functions of conditions, positions, or movements of the operator control features. The joystick 106 may include a portion with a handgrip or shape that is comfortable for an operator to grasp with a hand.

FIG. 2 depicts control inputs that may be functions of the displacement of the joystick 106 in relation to one or more axes. The one or more axes may include but are not limited to a side-to-side axis in the directions depicted by direction arrows 204 and 208, and a fore/aft axis in the directions depicted by direction arrows 202 and 206. The joystick 106 may moveable relative to a neutral position shown in FIG. 2. In one embodiment, displacement from the neutral position of the joystick 106 along the side-to-side may generate a first signal. The first signal may be indicative of a desired steering of the vehicle 300. Displacement of the joystick 106 along the fore/aft axis may generate a second signal. The vehicle 300 desired speed may be a function of the second signal. In another embodiment, the vehicle speed and direction may be a function of the second signal.

In the embodiment depicted in FIG. 2, when the joystick 106 is in a forward position 202 in relation to the neutral position, the vehicle 300 moves forward as depicted by vehicle direction icon 210b.

When the joystick 106 is in a forward right position in relation to the neutral position, the vehicle 300 moves forward and to the right as depicted by vehicle direction icon 210c.

When the joystick 106 is in a right position in relation to the neutral position, the vehicle 300 rotates clockwise as depicted by vehicle direction icon 210d.

When the joystick 106 is in a backward right position in relation to the neutral position, the vehicle 300 moves in reverse and to the right as depicted by vehicle direction icon 210h.

When the joystick 106 is in a backward position in relation to the neutral position, the vehicle 300 moves in reverse as depicted by vehicle direction icon 210g.

When the joystick 106 is in a backward left position in relation to the neutral position, the vehicle 300 moves in reverse and to the left as depicted by vehicle direction icon 210f.

When the joystick 106 is in a left position in relation to the neutral position, the vehicle 300 rotates counter-clockwise as depicted by vehicle direction icon 210e.

When the joystick 106 is in a forward left position in relation to the neutral position, the vehicle 300 moves forward and to the left as depicted by vehicle direction icon 210a.

In other embodiments movements in relation to the fore/aft axis and side-to-side axis may generate other movements as functions of the first signal and the second signal.

In another embodiment, the joystick 106 may include a twist axis (not shown). Twisting or rotating the joystick 106 around the twist axis may generate the first signal or the second signal.

In still other embodiments, operator control features may include buttons or other depressible devices, switches, rotatable members, and slidable members (not shown). Conditions, positions, or movements of the operator control features, may generate the first signal or the second signal.

Referring again to FIG. 1, the joystick 106 may include a resistive actuator 108, such as a linear or rotary brake. The resistive actuator 108 may be coupled to a shaft of the joystick 106. In one embodiment, the resistive actuator 108 may be a friction brake. In another embodiment, the resistive actuator 108 may be a fluid or fluid resistance device. In still another embodiment, the resistive actuator 108 may be a magneto-rheological or an electro-rheological fluid brake. Other types of brakes or rotary brakes may also be used. The resistive actuator 108 applies a braking or resistive force restricting or preventing movement of the joystick 106. In one embodiment the resistive actuator 108 may be a passive mechanical brake such as a friction brake. In another embodiment, the resistive actuator 108 may be electronically controlled by a controller 128.

The joystick 106 may include a detent 110. The detent 110 may position or hold the joystick 106 such that the joystick 106 can be released when force is applied. In one embodiment the detent 110 is a mechanical device with spring force. In another embodiment, the detent 110 is a part of an embodiment of the resistive actuator 108 which is electronically controlled by the controller 128. In this embodiment, the controller 128 may activate the resistive actuator 108 when the joystick 106 is in a particular position. The detent 110 may be when the joystick 106 is in the neutral position.

In alternative embodiments, the first operator control input device 104 may include switches, buttons, keyboards, interactive displays, levers, dials, remote control devices, voice activated controls, or any other operator input devices that a person skilled in the art would understand would be functional in the disclosed embodiments.

The second operator control input device 112 may include a pedal 114. The pedal 114 may include a lever or other depressible mechanism, apparatus, or device, operated by applying pressure. Depressing the pedal 114 may generate a third signal. The vehicle 300 desired speed may be a function of the third signal. The pedal 114 may be positioned between a left foot rest 126 and a right foot rest 126. In alternative embodiments the pedal may be positioned anywhere in the operator interface 102 where it can be depressed by an operator.

In alternative embodiments, the second operator control input device 112 may include switches, buttons, keyboards, interactive displays, levers, dials, remote control devices, voice activated controls, or any other operator input devices that a person skilled in the art would understand would be functional in the disclosed embodiments.

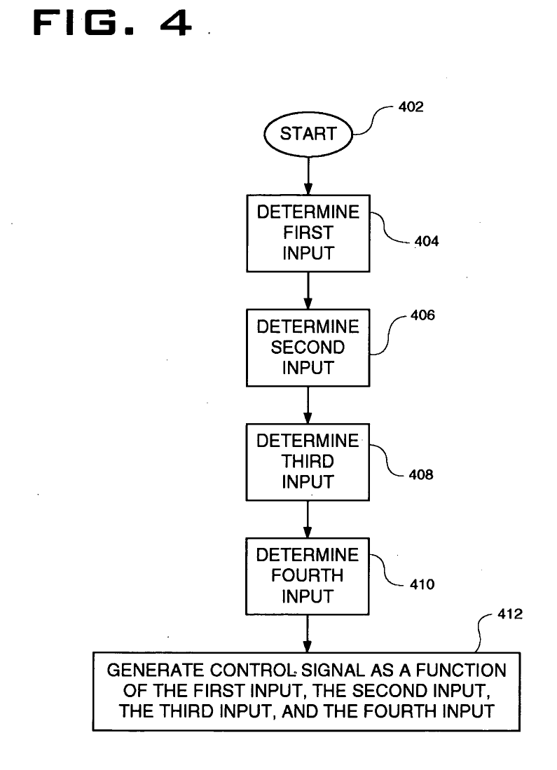

The third operator input device 116 may include two depressible buttons 118. The two depressible buttons 118 may be located on the joystick 106 or any other location where they can be actuated by an operator. The two depressible buttons 118 may be operable to generate a fourth signal. The fourth signal may be indicative of a power mode selection as described later in relation to FIG. 4. In an embodiment where the fourth signal is indicative of a power mode, the two depressible buttons may include a first button 212a and a second button 212b (see FIG. 2). Depressing the first button 212a may change the power mode selection in one way, and depressing the second button 212b may change the power mode selection in another way. For example, the first button 212a may select an increased power mode, and depressing the second button 212b may select a decreased power mode.

In alternative embodiments, the third operator control input device 116 may include switches, buttons, keyboards, interactive displays, levers, dials, remote control devices, voice activated controls, or any other operator input devices that a person skilled in the art would understand would be functional in the disclosed embodiments. The third operator control input device 116 may be located in any location where an operator may actuate it.

The operator interface 102 may include a display 120. The display 120 may include a visual representation of information. The display 120 may be an electronic display and may include but is not limited to LEDs, computer generated graphics, liquid crystal displays, and plasma displays. In alternative embodiments the display 120 may be a mechanical display and may include but is not limited to gauges, meters, and fluid levels. The display 120 may provide information on the operator control input devices 104, 112, 116. The information provided through the display 120 may include, but is not limited to joystick 106 position, power mode, and desired vehicle 300 speed.

In an embodiment where the fourth signal is indicative of a power mode selection, the display 120 may depict the power mode selection 140.

In an embodiment where the first operator control device 104 is a joystick 106, the joystick 106 displacement produces a second signal, and the direction of the vehicle 300 is a function of the second signal; the display 120 may depict the direction 142 of the vehicle 300.

The operator interface 102 may include the seat 122 for the operator. Alternative embodiments may anticipate the operator standing or operation of the operator control input devices 104, 112, 116 remotely.

The operator interface 102 may include the arm rest 124 situated in such a way that an operator's arm may rest on it while operating one or more of the operator control input devices 104, 112, 116.

The operator interface 102 may be operably connected to a propulsion system 130, a retarding system 132, a steering apparatus 134, and the controller 128. Operably connected includes being joined, fastened, or connected in such a manner that a first device is able to actuate, communicate with, or transfer power to another device. Operably connected may include any system or method for establishing communication and/or data transfer. Such systems or methods may include, mechanical connections, fluid connections, pneumatic connections, electronics, optics, radio, cellular, and/or sound techniques as well as others not expressly described herein and which would be contemplated by a person skilled in the art now or anytime in the future. Operably connected is not intended to be limited to a mechanical or hard-wired form of communication or data transfer.

The controller 128 may include a processor (not shown) and a memory component (not shown). The processor may be a microprocessor or other processor as known in the art. The processor may execute instructions and generate control signals for maintaining or modifying operation of the propulsion system, the steering apparatus, or the retarding system, as is described below in connection with FIGS. 4 and 5. Such instructions may be read into or incorporated into a computer readable medium, such as the memory component or provided external to processor. In alternative embodiments, hard-wired circuitry may be used in place of or in combination with software instructions to implement a control method. Thus embodiments are not limited to any specific combination of hardware circuitry and software.

The term “computer-readable medium” as used herein refers to any medium or combination of media that participates in providing instructions to processor for execution. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics, and can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer or processor can read.

The memory component may include any form of computer-readable media as described above. In the illustrated embodiment, the memory component is located on-board the vehicle 100. In an alternative embodiment, the memory component may be located remotely. In still another alternative embodiment, the memory component may include several types of computer readable media some located on-board and some located remotely.

The controller 128 is not limited to one processor and memory components. The controller 128 may be several processors and memory components. These multiple processors and memory components may be located on-board the vehicle 300 or off-board.

The controller 128 is not limited to electronic and electrical circuitry and software. In other embodiments the controller 128 may include hydraulic circuits, pneumatic circuits, mechanical control devices, or a combination of these and electronic and electrical circuitry and software may implement a control method.

The controller 128 may be operably coupled to the first operator control input device 104 to receive the first signal and second signal. The controller 128 may be operably coupled to the second operator control input device 112 to receive the third signal. The controller 128 may be operably coupled to the third operator control input device 116 to receive a signal indicative of a selection of power mode. The controller 128 may be operably coupled to the display 120 to provide information to the display 120.

The controller 128 may be operably coupled to the propulsion system 130 to transmit a control signal to the propulsion system 130. The controller 128 may be operably coupled to the retarding system 132 to transmit a control signal to the retarding system 132. The controller 128 may be operably coupled to the steering apparatus 134 to transmit a control signal to the steering apparatus 134.

Referring now to FIG. 3, an exemplary embodiment of a vehicle 300 is illustrated. In the illustrated embodiment the vehicle 300 includes a track loader 302. In alternative embodiments the vehicle 300 may include any mobile machine. Vehicle 300 may include but is not limited to machines that transport passengers, goods, and apparatus. Vehicle 300 may include but is not limited to work vehicles that perform some type of operation associated with a particular industry such as mining, construction, farming, transportation, etc. and operate between or within work environments (e.g. construction site, mine site, power plants, on-highway applications, etc.). Vehicle 300 may include any type of automobile or commercial vehicle. Non-limiting examples of vehicle 300 include on-highway vehicles, commercial machines such as trucks, cranes, earthmoving vehicles, mining vehicles, backhoes, loaders, material handling equipment, farming equipment, marine vessels, aircraft, and any type of movable machine. Vehicle 300 may include mobile machines which operate on land, in water, in the earth's atmosphere, or in space. Land vehicles 300 may include mobile machines with tires, tracks, or other ground engaging devices.

Track loader 302 may include right track 304, left track 306, operator interface 102, controller 128, and propulsion system 130. In the embodiment illustrated in FIG. 3, the propulsion system 130 includes the retarding system 132 and the steering apparatus 134. In alternative embodiments the propulsion system 130, the retarding system 132, and the steering apparatus 134 may be separate.

The propulsion system 130 may include an engine 308, a transmission 310, a left track drive 312, and a right track drive 314. In other embodiments the propulsion system may include any group of interacting, interrelated, or interdependent elements acting as a whole; or the totality of means; which is functional to drive the vehicle 300 in a direction or cause the vehicle 300 to move. The propulsion system 130 may include any power source. In alternative embodiments the power source may include but is not limited to a battery, an electric power generator, a pump, or a fuel cell. The power source may be mechanical, electrical, hydraulic, or pneumatic. The transmission 310 may include a Hydrostat CVT. In alternative embodiments, the transmission may include but is not limited to a mechanical transmission, any CVT, gearing, belts, pulleys, discs, chains, pumps, motors, clutches, brakes, and torque converters. In some embodiments the propulsion system 130 may not have a transmission. For example an aircraft propulsion system 130 may have jet engines which do not require a transmission to propel the aircraft.

In one embodiment the transmission 310, the left track drive 312, and the right track drive 314 may include a first and a second hydraulic pump and a first and a second hydraulic motor. The first and the second hydraulic pump may be driven by the engine 308 or an alternative power source. The first hydraulic pump may drive the first hydraulic motor which in turn drives the left track 306. The second hydraulic pump may drive the second hydraulic motor which in turn drive the right track 304.

The engine 308 may be a diesel internal combustion engine. In another embodiment the engine 308 may be a gasoline engine or a jet engine. The engine 308 may be operably coupled to the Hydrostat CVT 310. The Hydrostat CVT may be operably coupled to the left track driver 312 and the right track driver 314.

The left track driver 312 and the right track driver 314 may drive the left track 306 and the right track 304 respectively, and thus propel the vehicle 300 in a direction. In other land vehicle 300 embodiments wheels or other ground engaging devices may replace the tracks 306, 304. Marine vehicles 300 may include an engine 308 or other power source and a transmission which may drive propellers. In other marine vehicles 300 an engine 308 may directly drive the propeller or the propulsions system 130 may include jet engines.

The retarding system 132 may include a totality of means; or a group of interacting, interrelated, or interdependent elements acting as a whole; which are functional to decrease the speed or movement of the vehicle 300. The retarding system may include a brake in the engine 308, the hydrostat CVT 310, the left track driver 312 and the right track driver 314, or any combination of these elements. The retarding system 132 may include but is not limited to mechanical, electrical, hydraulic, pneumatic, and friction based retarding devices. On land based vehicles 300, some embodiments may include brakes on ground engaging devices.

The steering apparatus 134 may include a totality of means; or a group of interacting, interrelated, or interdependent elements acting as a whole; which is functional to guide or direct a vehicle 300. The embodiment of the steering apparatus illustrated in FIG. 3 includes the left track driver 312 and the right track driver 314. By controlling the speed of the left track driver 312 and the right track driver 314, the track loader 302 may be steered. If the left track 306 moves faster than the right track 304, the track loader 302 may steer to the right. Conversely, if the right track 304 moves faster than the left track 306, the track loader 302 may turn to the left. If both the right track 304 and the left track 306 move at the same speed, the track loader 302 may move in a straight line.

In alternative embodiments the steering apparatus 134 may include mechanical gearing, hydraulic cylinders, or other mechanical devices to move ground engaging devices to angles which steer the vehicle 300. On marine vehicles 300 or aircraft vehicles 300 the steering apparatus 134 may include rudders. In other embodiments on marine vehicles 300 or aircraft vehicles 300 the steering apparatus 134 may include multiple engines 308 which are controlled to steer the vehicle 300.

### INDUSTRIAL APPLICABILITY

Referring now to FIG. 4, a method of controlling a vehicle 300 is depicted. The method may include the step of determining a first input 404. The first input may be a first signal generated by a first operator control device 104 and may be indicative of a desired steering of a vehicle 300. In one embodiment, the first input may be a first signal generated by the displacement of a joystick 106 from a neutral position along a side-to-side axis. The joystick 106 may include a sensor (not shown) that is configured to generate the first signal. The sensor may be an electronic sensor. The controller 128 may be configured in a manner to receive the first signal and determine a desired steering of the vehicle 300.

The method may include the step of determining a second input 406. The second input may be a second signal generated by the first operator control device 104. The desired speed of the vehicle 300 may be a function of the second signal. In one embodiment, the second input may be a second signal generated by the displacement of a joystick 106 from a neutral position along a fore/aft axis. The joystick 106 may include a sensor (not shown) that is configured to generate the second signal. The sensor may be an electronic sensor. The controller 128 may be configured in a manner to receive the second signal and determine a desired vehicle 300 speed as a function of the second signal.

In an alternative embodiment, the desired speed and the desired direction of the vehicle 300 may be a function of the second signal. For example, the second input may be a second signal generated by the displacement of a joystick 106 from a neutral position along a fore/aft axis. The joystick 106 may include a sensor (not shown) that is configured to generate the second signal. The sensor may be an electronic sensor. The controller 128 may be configured in a manner to receive the second signal and determine a desired vehicle 300 speed as a function of the second signal.

The method may include the step of determining a third input 408. The third input may be the third signal generated by a second operator control device 112. The desired speed of the vehicle 300 may be a function of the third signal. In one embodiment, the third input may be the third signal generated by the position of the pedal 114. The pedal 114 may include a sensor (not shown) that is configured to generate the third signal. The sensor may be an electronic sensor. The controller 128 may be configured in a manner to receive the third signal and determine a desired vehicle 300 speed as a function of the second signal.

In one embodiment, the position of the joystick 106 may be determinative of vehicle 300 speed and a desired steering of the vehicle 300. If an operator is steering around obstacles or making sharp turns, it may be difficult to position the joystick 106 for both the desired vehicle 300 speed and a desired steering of the vehicle 300. The operator may retard the vehicle 300 speed with the second operator control input 112. In one embodiment where the second operator control input 112 is the pedal 114, the operator may be able to steer the vehicle 300 with his hand through a joystick 106 and moderate the vehicle 300 speed with his foot through the pedal 114.

The method may include the step of determining a fourth input 410. The fourth input may be the fourth signal generated by the third operator control device 116. In one embodiment, the fourth input may be a fourth signal generated by the two depressible buttons 118, indicative of a selected power mode. The two depressible buttons 118 may include a sensor (not shown) that is configured to generate the fourth signal. The sensor may be an electronic sensor. The controller 128 may be configured in a manner to receive the fourth signal and determine a vehicle 300 power mode as a function of the second signal.

The vehicle 300 may have a plurality of power modes. In one power mode the propulsion system 130 may be controlled in a manner where 100% of available power is made available to propel the vehicle 300. In another power mode, the propulsion system 130 may be controlled in a manner where 70% of available power is made available to propel the vehicle 300. In still another power mode, the propulsion system 130 may be controlled in a manner where 55% of available power is made available to propel the vehicle 300. In still another power mode, the propulsion system 130 may be controlled in a manner where 45% of available power is made available to propel the vehicle 300.

In one embodiment, when a power mode is selected, the desired vehicle 300 speed command from the first operator control input device 104 may be scaled to match the power mode. For example, if 70% power mode is chosen, the maximum desired vehicle speed may be 70% of the maximum desired speed if the 100% power mode were chosen. If an operator is trying to control the vehicle at a lower speed where more maneuvering is necessary, scaling the desired vehicle 300 speed may be desirable.

The disclosure contemplates that the fourth input may be a choice of two power modes, it may be a choice of three power modes, it may be the choice of four power modes, or it may be the choice of a larger number of power modes. The disclosure contemplates that the percent power of each mode may be any percent between 0 and 100.

The method may include the step of generating a control signal as a function of the first input, the second input, the third input, and the fourth input 412. The method may include the step of determining a control signal operable to maintain or modify the operation of the propulsion system 130, the retarding system 132, or the steering apparatus 134. In one embodiment, the control signal may modify the operation of the propulsion system 130 or the retarding system 130 to obtain a desired vehicle 300 speed. In another embodiment the control signal may be operable to modify or maintain the operation of the steering apparatus 134 to obtain a desired steering of the machine. In some embodiments, the control signal may be operable to modify or maintain the operation of the propulsion system 130 or the retarding system 132 to obtain a desired vehicle 300 speed, and be operable to modify or maintain the operation of the steering apparatus to obtain a desired vehicle 300 steering

The controller 128 may be configured in a manner to receive the first signal, the second signal, the third signal and the fourth signal. The controller 128 may be configured in a manner to determine a desired vehicle 300 speed and a desired vehicle 300 steering as a function of the first signal, the second signal, the third signal and the fourth signal. The controller 128 may be configured in a manner to generate a control signal to maintain or modify the operation of propulsion system 130, the retarding system 132, or the steering apparatus 134 to obtain the desired vehicle 300 speed and the desired vehicle 300 steering.

In one embodiment including a track loader 302, the joystick 106 may generate the first signal indicative of a desired steering as a function of the displacement from a neutral position 208 on a side-to-side axis 204; and generate the second signal indicative of a desired speed as a function of the displacement from a neutral position 208 on a fore/aft axis 202. The pedal 114 may generate the third signal as a function of the position of the pedal 114 indicative of a desired speed. The two depressible buttons 118 may generate the fourth signal indicative of a power mode selection. The controller 128 may be configured to receive the first signal, the second signal, the third signal, and the fourth signal and determine a desired steering and a desired speed. The controller 128 may be configured to generate a control signal to modify or maintain the operation of the engine 308, the transmission 310, the left track driver 312, and the right track driver 314, to obtain the desired speed and desired steering through modification or maintenance of the left track 306 speed and the right track 304 speed.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. An operator interface for controlling a vehicle, comprising:
a first operator control input device configured to generate a first signal indicative of a desired steering of the vehicle and a second signal; and
a second operator control input device configured to generate a third signal,
wherein the second signal and the third signal are indicative of a desired vehicle speed.

2. The operator interface of claim 1, further comprising a third operator control input device configured to select one of at least two power modes.

3. The operator interface of claim 1, wherein the first operator control input device is a joystick.

4. The operator interface for of claim 3, wherein the joystick includes a resistive actuator.

5. The operator interface of claim 3, wherein:
the joystick is moveable relative to a neutral position, and
a displacement of the joystick from the neutral position in a direction is indicative of the desired steering of the vehicle.

6. The operator interface of claim 5, wherein the joystick is biased to the neutral position.

7. The operator interface of claim 3, wherein:
the joystick is moveable relative to a neutral position, and
the second signal is a function of a displacement of the joystick from the neutral position in a direction.

8. The operator interface of claim 7, wherein the joystick includes a detent in the neutral position.

9. The operator interface of claim 3, wherein the joystick includes a rotatable member, and one of the first signal and the second signal is a function of the angular rotation position of the rotatable member.

10. The operator interface of claim 3, wherein the joystick includes a depressible interface, and one of the first signal and the second signal is a function of depressing the depressible interface.

11. The operator interface of claim 3, wherein the second operator control input device is a pedal.

12. The operator interface of claim 2, wherein the at least two power modes include a first power mode and a second power mode wherein the power available to the vehicle in the second power mode is less than in the first power mode.

13. The operator interface of claim 11, wherein:
the at least two power modes include a first power mode, a second power mode, a third power mode, and a fourth power mode,
the power available to the vehicle in the second power mode is less than in the first power mode,
the power available to the vehicle in the third power mode is less than in the second power mode, and
the power available to the vehicle in the fourth power mode is less than in the third power mode.

14. The operator interface of claim 2, further comprising a display depicting a current power mode.

15. A vehicle, comprising:
a propulsion system,
a steering apparatus,
a retarding system,
the operator interface of claim 1,
a controller configured to deliver a control signal to at least one of the propulsion system, the steering apparatus, and the retarding system as a function of the first signal, the second signal, and the third signal.

16. The vehicle of claim 15, further comprising a third operator control input device configured to select one of at least two power modes, wherein:
the first operator control input device is a joystick, and
the second operator control input device is a pedal.

17. A method for controlling a vehicle, comprising:
determining a first input from a first operator control input device indicative of a desired steering,
determining a second input from the first operator control input,
determining a third input from a second operator control input, wherein the second input and the third input are indicative of a desired vehicle speed, and
delivering a control signal to at least one of the propulsion system, steering apparatus, and retarding system as a function of the first input, the second input, and the third input.

18. The method of claim 17, further comprising the steps of:
determining a fourth input from a third operator control input device indicative of a power mode, and
delivering a control signal to at least one of the propulsion system, steering apparatus, and retarding system as a function of the first input, the second input, the third input, and the fourth input.

19. The method of claim 18, wherein:
the first operator control input device is a joystick,
the second operator control input device is a pedal, and
the third operator control input device is one or more depressible buttons.

20. The method of claim 19, wherein:
the first input is a function of the displacement of the joystick in a first direction,
the second input is a function of the displacement of the joystick in a second direction,
the third input is a function of the position of the pedal, and
the fourth input is a function of depressing one or more depressible buttons.
